(19) United States
(12) Patent Application Publication
(10) Pub. No.: US 2016/0210105 A1
(43) Pub. Date: Jul. 21, 2016

(54) METHOD, DEVICE AND SYSTEM FOR PROJECTION ON SCREEN

(71) Applicant: Xiaomi Inc., Beijing (CN)

(72) Inventors: Yi RU, Beijing (CN); Xin LIANG, Beijing (CN); Xianzhe WEI, Beijing (CN); Xuetong CHEN, Beijing (CN); Guizhou WU, Beijing (CN); Yongzhi WANG, Beijing (CN)

(73) Assignee: Xiaomi Inc., Beijing (CN)

(21) Appl. No.: 14/993,526

(22) Filed: Jan. 12, 2016

(30) Foreign Application Priority Data
Jan. 15, 2015 (CN) 201510020809.5

(51) Int. Cl. G06F 3/14; H04W 4/00; H04L 29/06; H04W 76/02

(52) U.S. Cl. CPC G06F 3/1454; H04W 76/023; H04W 4/008; H04L 65/608; G06F 3/1423; H04W 84/12

(57) ABSTRACT

The present disclosure relates to a method, a device and a system in a smart home system for projection on a screen. The method may include: receiving predetermined type of signal, and establishing a predetermined type of connection with a second electronic device which sends the predetermined type of signal; according to the predetermined type of connection, notifying the second electronic device to start a WiFi P2P connection service; and after the first electronic device starting the WiFi P2P connection service, establishing a WiFi P2P connection with the second electronic device which has started the WiFi P2P connection service, and performing projection on a screen of the second electronic device.

### PRIORITY STATEMENT

The present application is based upon and claims priority to Chinese Patent Application No. 201510020809.5, filed Jan. 15, 2015, the entirety of which is incorporated herein by reference.

### TECHNICAL FIELD

The present disclosure generally relates to the field of smart homes, and more particularly to, a method, a device and a system for projection on a screen.

### BACKGROUND

A projection technology that projects information on a screen of a first electronic device onto a screen of a second electronic device has become a demand trend in smart homes.

When performing projection on a screen, the first electronic device and the second electronic device should simultaneously start a particular application program installed therein upon operation by a user. After the particular application program is started, the first electronic device and the second electronic device may automatically start their wireless fidelity (WiFi) peer-to-peer (P2P) connection services. The first electronic device scans, via a wireless display application program, through the second electronic devices which have started the WiFi P2P connection service, and displays second electronic devices that it detects through the scanning through procedure, and then a user may select one of the displayed second electronic devices. The first electronic device then establishes a WiFi P2P connection between the first electronic device and the selected second electronic device upon selection by the user and performs projection on a screen after the establishment of the WiFi P2P connection.

### SUMMARY

Embodiments of the present disclosure provide a method, a device and a system for projection on a screen. The technical solutions are as follows:

According to an aspect of the present disclosure, a smart system may include a first electronic device. The first electronic device includes a non-transitory processor-readable storage medium including a set of instructions for wirelessly projecting a document to another electronic device and a target document; and a processor in communication with the storage medium. Further, when executing the set of instructions, the processor is directed to: receive at least one wireless signal respectively broadcasted from at least one second electronic device; automatically establish a wireless connection with a target second electronic device from the at least one second electronic device; automatically notifying the target second electronic device to start a wireless fidelity peer-to-peer (WiFi P2P) connection service according to the wireless connection; automatically establishing a WiFi P2P connection with the target second electronic device; and send a visual portion of the target document to the target second electronic device through the WiFi P2P connection to display the visual portion on a screen of the target second electronic device.

According to another aspect of the present disclosure, a method for projecting a document on a screen may include receiving, by a first electronic device, at least one wireless signal respectively broadcasted from at least one second electronic device; automatically establishing, by the first electronic device, a wireless connection with a target second electronic device from the at least one second electronic device; automatically notifying, by the first electronic device, the target second electronic device to start a wireless fidelity peer-to-peer (WiFi P2P) connection service according to the wireless connection; establishing, by the first electronic device, a WiFi P2P connection with the target second electronic device; and sending, by the first electronic device, a visual portion of a target document displayed on the first electronic device to the target second electronic device through the WiFi P2P connection to display the visual portion on a screen of the target second electronic device.

According to yet another aspect of the present disclosure, a non-transitory processor-readable storage medium may include a set of instructions for wirelessly projecting a document from a first electronic device to another electronic device; and a target document. When executed by a processor of the first electronic device, the set of instruction directs the processor to perform acts of: receiving at least one wireless signal respectively broadcasted from at least one second electronic device; automatically establishing a wireless connection with a target second electronic device from the at least one second electronic device; automatically notifying the target second electronic device to start a wireless fidelity peer-to-peer (WiFi P2P) connection service according to the wireless connection; establishing a WiFi P2P connection with the target second electronic device; and sending a visual portion of a target document displayed on the first electronic device to the target second electronic device through the WiFi P2P connection to display the visual portion on a screen of the target second electronic device.

The technical solutions provided by embodiments of the present disclosure may have the following advantageous effects. A predetermined type of connection with a second electronic device is automatically established according to received broadcast signal. Then, under the predetermined type of connection, a WiFi P2P connection service of the second electronic device is started and a WiFi P2P connection is established to perform projection on a screen. The received predetermined type of signal is sent by broadcast through the second electronic device by default, and thus there is no need to install particular application program in the first electronic device and the second electronic device, and a WiFi P2P connection is established without user's manual operation. Thus, the present disclosure may solve the problem in the related arts that particular application program needs to be installed in the first electronic device and the second electronic device, a WiFi P2P connection may be established upon user's operation only after the user simultaneously starts the particular application program in the two electronic devices by user's operation, resulting in cumbersome operations and low connection efficiency when performing projection on a screen. Consequently, the WiFi P2P connection may be established automatically, the connection efficiency when performing projection on a screen may be improved and user's operations may be reduced.

It is to be understood that both the foregoing general description and the following detailed description are exemplary only and are not restrictive of the present disclosure.

### BRIEF DESCRIPTION OF THE DRAWINGS

The accompanying drawings, which are incorporated in and constitute a part of this specification, illustrate embodiments consistent with the present disclosure and, together with the description, serve to explain the principles of the present disclosure.

FIG. 1 is a block diagram showing an implementation environment for a method of projecting on a screen according to a part of exemplary embodiments;

FIG. 2 is a flowchart showing a method of projecting on a screen according to an exemplary embodiment;

FIG. 3 is a flowchart showing a method of projecting on a screen according to another exemplary embodiment;

FIG. 4A is a flowchart showing a method of projecting on a screen according to another exemplary embodiment;

FIG. 4B is a flowchart illustrating a procedure of establishing a predetermined type of connection between a first electronic device and a second electronic device that sends predetermined type of signal according to another exemplary embodiment;

FIGS. 4C to 4F are flowcharts illustrating procedures of establishing a predetermined type of connection between a first electronic device and a second electronic device that qualifies a preset condition among a plurality of second electronic devices according to various exemplary embodiments;

FIG. 4G is a flowchart illustrating a procedure that a first electronic device performs projection on a screen of a second electronic device according to another exemplary embodiment;

FIG. 4H is a block diagram illustrating a procedure to synchronously display screen information of a first electronic device on a screen of a second electronic device according to another exemplary embodiment;

FIG. 4I is a block diagram illustrating a procedure to perform projection on two screens of two different types of second electronic devices according to another exemplary embodiment;

FIG. 5 is a block diagram showing a device for projection on a screen according to another exemplary embodiment;

FIG. 6 is a block diagram showing a device for projection on a screen according to another exemplary embodiment;

FIG. 7 is a block diagram showing a device for projection on a screen according to another exemplary embodiment;

FIG. 8 is a block diagram showing a device for projection on a screen according to another exemplary embodiment; and

FIG. 9 is a block diagram showing a device for projection on a screen according to another exemplary embodiment.

### DETAILED DESCRIPTION

Reference will now be made in detail to exemplary embodiments, examples of which are illustrated in the accompanying drawings. The following description refers to the accompanying drawings in which the same numbers in different drawings represent the same or similar elements unless otherwise represented. The implementations set forth in the following description of exemplary embodiments do not represent all implementations consistent with the present disclosure. Instead, they are merely examples of devices and methods consistent with aspects related to the present disclosure as recited in the appended claims.

The present disclosure solves the problem in the related arts that particular application program needs to be installed in the first electronic device and the second electronic device, a WiFi P2P connection may be established upon user's operation only after the user simultaneously starts the particular application program in the two electronic devices by user's operation, resulting in cumbersome operations and low connection efficiency when performing projection on a screen. Consequently, the WiFi P2P connection may be established automatically, the connection efficiency when performing projection on a screen may be improved and user's operations may be reduced.

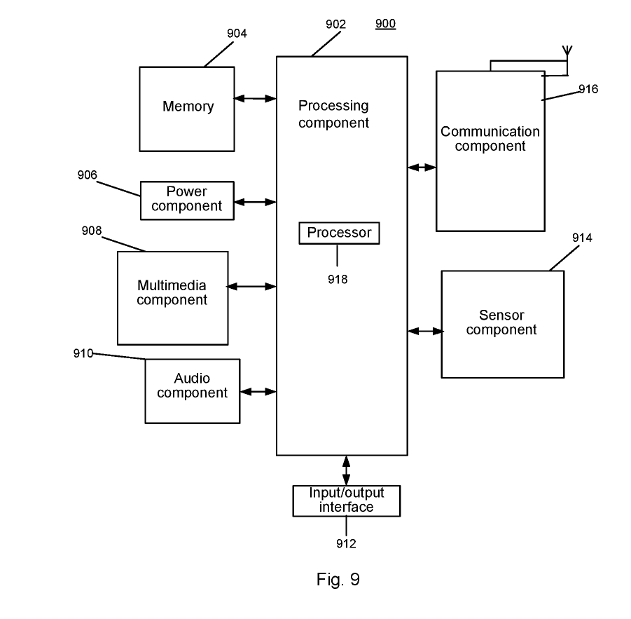

FIG. 9 is a block diagram showing a device for projection on a screen according to an exemplary embodiment. For example, the device 900 may be a mobile phone having a displaying function with a screen, a computer, a digital broadcast terminal, a messaging device, a gaming console, a tablet, a medical device, exercise equipment, a personal digital assistant, and the like. The device may also be a smart device such as a smart phone, a tablet computer, a smart TV, an e-book reader, a multimedia player, a laptop portable computer or a desk computer and the like.

The device 900 may include one or more of the following components: a processing component 902, a memory 904, a power component 906, a multimedia component 908, an audio component 910, an input/output (I/O) interface 912, a sensor component 914, and a communication component 916.

The processing component 902 may control overall operations of the device 900, such as the operations associated with display, telephone calls, data communications, camera operations, and recording operations. The processing component 902 may include one or more processors 918 to execute instructions saved in the memory to perform all or part of the steps in the systems and/or methods described in the present disclosure. Moreover, the processing component 902 may include one or more modules which facilitate the interaction between the processing component 902 and other components. For instance, the processing component 902 may include a multimedia module to facilitate the interaction between the multimedia component 908 and the processing component 902.

The memory 904 may be configured to store various types of data to support the operation of the device 900. Examples of such data include instructions for any applications or methods operated on the device 900, contact data, phonebook data, messages, pictures, video, etc. The memory 904 may be implemented using any type of volatile or non-volatile memory devices, or a combination thereof, such as a static random access memory (SRAM), an electrically erasable programmable read-only memory (EEPROM), an erasable programmable read-only memory (EPROM), a programmable read-only memory (PROM), a read-only memory (ROM), a magnetic memory, a flash memory, a magnetic or optical disk.

The power component 906 may provide power to various components of the device 900. The power component 906 may include a power management system, one or more power sources, and any other components associated with the generation, management, and distribution of power in the device 900.

The multimedia component 908 may include a screen providing an output interface between the device 900 and the user. In some embodiments, the screen may include a liquid crystal display (LCD) and a touch panel (TP). If the screen includes the touch panel, the screen may be implemented as a touch screen to receive input signal from the user. The touch panel may include one or more touch sensors to sense touches, swipes, and gestures on the touch panel. The touch sensors may not only sense a boundary of a touch or swipe action, but also sense a period of time and a pressure associated with the touch or swipe action. In some embodiments, the multimedia component 908 may include a front camera and/or a rear camera. The front camera and/or the rear camera may receive an external multimedia datum while the device 900 is in an operation mode, such as a photographing mode or a video mode. Each of the front camera and the rear camera may be a fixed optical lens system or have focus and optical zoom capability.

The audio component 910 may be configured to output and/or input audio signal. For example, the audio component 910 may include a microphone (“MIC”) configured to receive an external audio signal when the device 900 is in an operation mode, such as a call mode, a recording mode, and a voice recognition mode. The received audio signal may be further stored in the memory 904 or transmitted via the communication component 916. In some embodiments, the audio component 910 further may include a speaker to output audio signals.

The I/O interface 912 may provide an interface between the processing component 902 and peripheral interface modules, such as a keyboard, a click wheel, buttons, and the like. The buttons may include, but are not limited to, a home button, a volume button, a starting button, and a locking button.

The sensor component 914 may include one or more sensors to provide status assessments of various aspects of the device 900. For instance, the sensor component 914 may detect an open/closed status of the device 900, relative positioning of components, e.g., the display and the keypad, of the device 900, a change in position of the device 900 or a component of the device 900, a presence or absence of user contact with the device 900, an orientation or an acceleration/deceleration of the device 900, and a change in temperature of the device 900. The sensor component 914 may include a proximity sensor configured to detect the presence of nearby objects without any physical contact. The sensor component 914 may also include a light sensor, such as a CMOS or CCD image sensor, for use in imaging applications. In some embodiments, the sensor component 914 may also include an accelerometer sensor, a gyroscope sensor, a magnetic sensor, a pressure sensor, or a temperature sensor.

The communication component 916 may be configured to facilitate communication, wired or wirelessly, between the device 900 and other devices. The device 900 can access a wireless network based on a communication standard, such as WiFi, 2G, or 3G, or a combination thereof. In one exemplary embodiment, the communication component 916 may receive a broadcast signal or broadcast associated information from an external broadcast management system via a broadcast channel. In one exemplary embodiment, the communication component 916 further may include a near field communication (NFC) module to facilitate short-range communications. For example, the NFC module may be implemented based on a radio frequency identification (RFID) technology, an infrared data association (IrDA) technology, an ultra-wideband (UWB) technology, a Bluetooth (BT) technology, and other technologies.

In exemplary embodiments, the device 900 may be implemented with one or more application specific integrated circuits (ASICs), digital signal processors (DSPs), digital signal processing devices (DSPDs), programmable logic devices (PLDs), field programmable gate arrays (FPGAs), controllers, micro-controllers, microprocessors, or other electronic components, for performing the above described methods.

In exemplary embodiments, there is also provided a non-transitory computer readable storage medium including instructions, such as included in the memory 904, executable by the processor 918 in the device 900, for performing the above-described methods. For example, the non-transitory computer-readable storage medium may be a ROM, a RAM, a CD-ROM, a magnetic tape, a floppy disc, an optical data storage device, and the like.

The device shown in FIG. 9 may be implemented in the systems, electronic devices, and methods as described in the present disclosure.

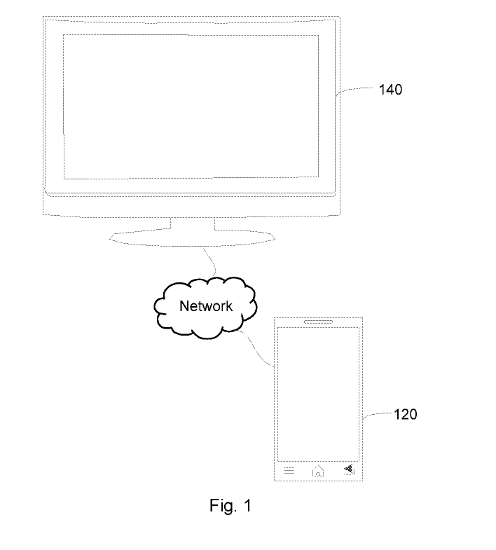

FIG. 1 is a block diagram showing an implementation environment for a method of projecting on a screen according to a part of exemplary embodiments. As shown in FIG. 1, the implementation environment may include a first electronic device 120 and a second electronic device 140.

The second electronic device 140 is an electronic device having a displaying function with a screen and capable of broadcasting predetermined types of signals, for example, Bluetooth signals, Near Field Communication (NFC) signals, and the like. Generally, the second electronic device 140 has hardware devices for broadcasting signals of a predetermined type, for example, Bluetooth chips or NFC chips, and the like.

The first electronic device 120 is an electronic device having a displaying function with a screen and capable of receiving the predetermined type of signal broadcast by the second electronic device 140 and recognizing the predetermined type of signal. Accordingly, the first electronic device 120 has receiving antennas for receiving a predetermined type of signal provided therein.

The types of the first electronic device 120 and the second electronic device 140 may be the same or not. For example, both the first electronic device 120 and the second electronic device 140 may have a structure as shown in FIG. 9. Both the first electronic device 120 and the second electronic device 140 may be a smart phone, a tablet computer, a smart TV, an e-book reader, a multimedia player, a laptop portable computer or a desk computer and the like.

The size of the screen of the first electronic device 120 may be smaller than the size of the screen of the second electronic device 140.

Also, the resolution of the screen of the first electronic device 120 may be smaller than the resolution of the screen of the second electronic device 140. As a result, an audio visual document, such as movie, may have a better visual effect when displayed in the second electronic device 140 than displayed in the first electronic device 120.

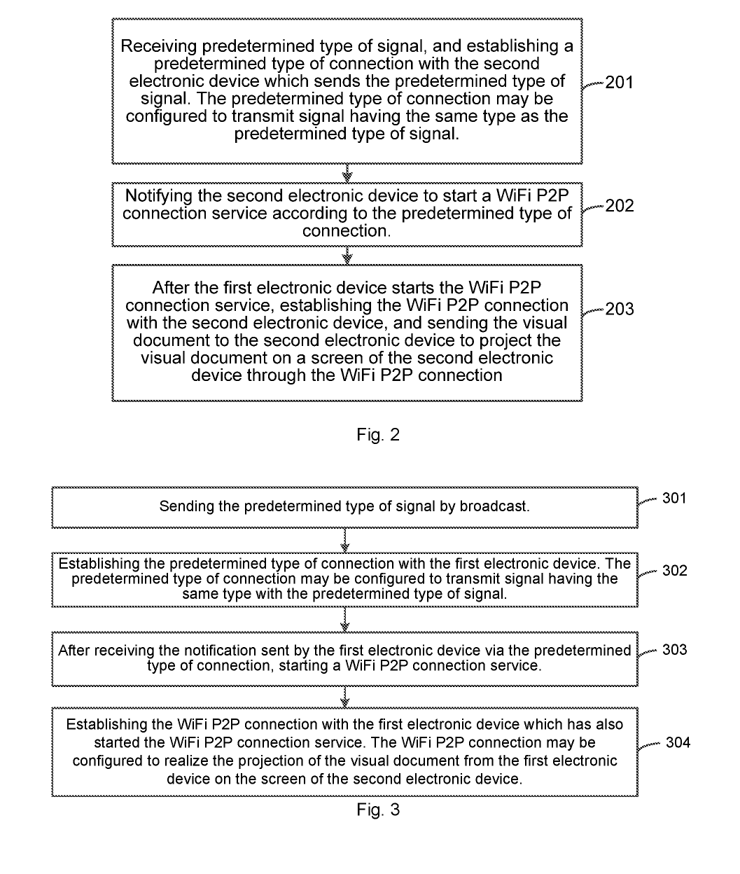

FIG. 2 is a flowchart showing a method of projecting a visual document on a screen according to an exemplary embodiment. As shown in FIG. 2, the method of projecting on a screen is applied in the first electronic device 120 in the implementation environment shown in FIG. 1. Accordingly, a processor of the electronic device 120 may execute a set of instructions stored in a non-transitory processor-readable storage medium of the electronic device 120, and is directed by the set of instructions to perform the following acts.

In step 201, receiving predetermined type of signal, and establishing a predetermined type of connection with the second electronic device which sends the predetermined type of signal. The predetermined type of connection may be configured to transmit signal having the same type as the predetermined type of signal.

Generally, the predetermined type of signal is sent from other devices by broadcast, and the first electronic device may receive the predetermined type of signal sent from the other devices by broadcast.

In step 202, notifying the second electronic device to start a WiFi P2P connection service according to the predetermined type of connection.

In step 203, after the first electronic device starts the WiFi P2P connection service, establishing the WiFi P2P connection with the second electronic device which has started the WiFi P2P connection service, and performing to send the visual document to the second electronic device and project the visual document on a screen of the second electronic device through the WiFi P2P connection. The visual document may be an image, a video document, a PPT file, or any other type of document that need to visually presented to a user.

In conclusion, in the method of projecting on a screen provided by the embodiment of the present disclosure, a predetermined type of connection with a second electronic device is automatically established according to received broadcast signal. Then, under the predetermined type of connection, a WiFi P2P connection service of the second electronic device is started and a WiFi P2P connection is established to perform projection on a screen. The received predetermined type of signal is sent by broadcast through the second electronic device by default, and thus there is no need to install particular application program in the first electronic device and the second electronic device, and a WiFi P2P connection is established without user's manual operation. Thus, the present embodiment may solve the problem in the related arts where a particular application program needs to be installed in the first electronic device and the second electronic device, and a WiFi P2P connection may be established upon user's operation only after the user simultaneously starts the particular application program in the two electronic devices by user's operation, resulting in cumbersome operations and low connection efficiency when performing projection on a screen. As disclosed herein, a WiFi P2P connection may be established automatically, the connection efficiency when performing projection on a screen may be improved and a user's operations may be reduced.

FIG. 3 is a flowchart showing a method of projecting a visual document on a screen according to another exemplary embodiment. As shown in FIG. 3, the method of projecting on a screen is applied in the second electronic device 140 in the implementation environment shown in FIG. 1. Accordingly, a processor of the electronic device 140 may execute a set of instructions stored in a non-transitory processor-readable storage medium of the electronic device 140, and is directed by the set of instructions to perform the following acts.

In step 301, sending the predetermined type of signal by broadcast.

In step 302, establishing the predetermined type of connection with the first electronic device. The predetermined type of connection may be configured to transmit signal having the same type with the predetermined type of signal.

In step 303, after receiving the notification sent by the first electronic device via the predetermined type of connection, starting a WiFi P2P connection service.

In step 304, establishing the WiFi P2P connection with the first electronic device which has also started the WiFi P2P connection service. The WiFi P2P connection may be configured to realize the projection of the visual document from the first electronic device on the screen of the second electronic device.

In conclusion, in the method of projecting on a screen provided by the embodiment of the present disclosure, predetermined type of signal is broadcast and thus a first electronic device may receive the predetermined type of signal. Thereby, a predetermined type of connection may be automatically established with a second electronic device. Then, under the predetermined type of connection, a WiFi P2P connection service of the second electronic device is started, and a WiFi P2P connection is established to perform projection on a screen. The second electronic device may send the predetermined type of signal by broadcast, and there is no need to install particular application program and no cumbersome operations of a user is needed. Thus, similar to the embodiment of FIG. 2, utilizing the embodiment of FIG. 3 the WiFi P2P connection may be established automatically, the connection efficiency when performing projection on a screen may be improved and user's operations may be reduced.

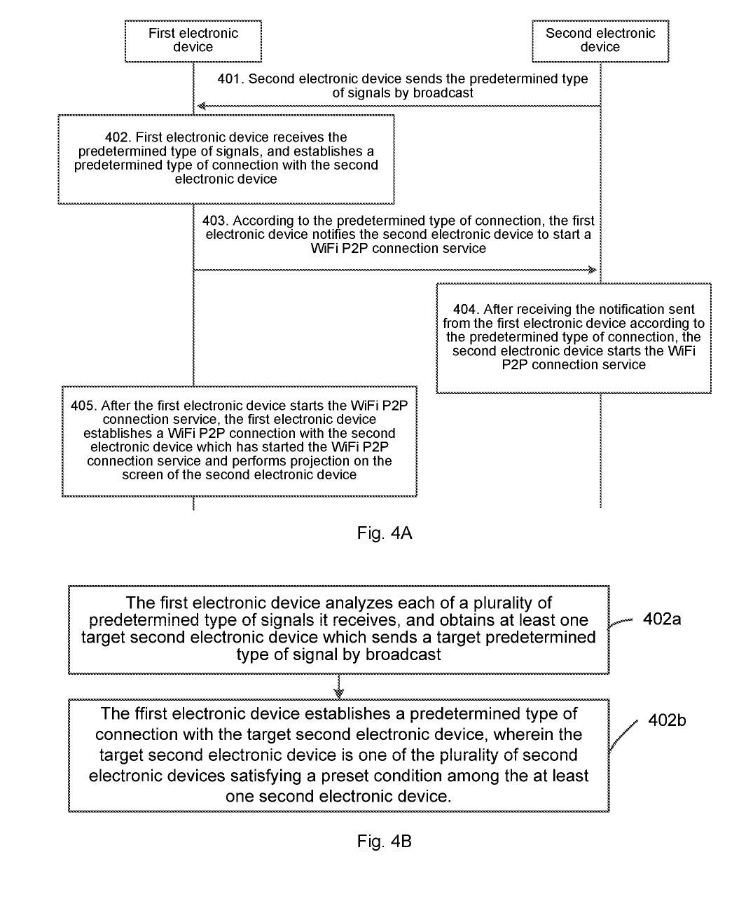

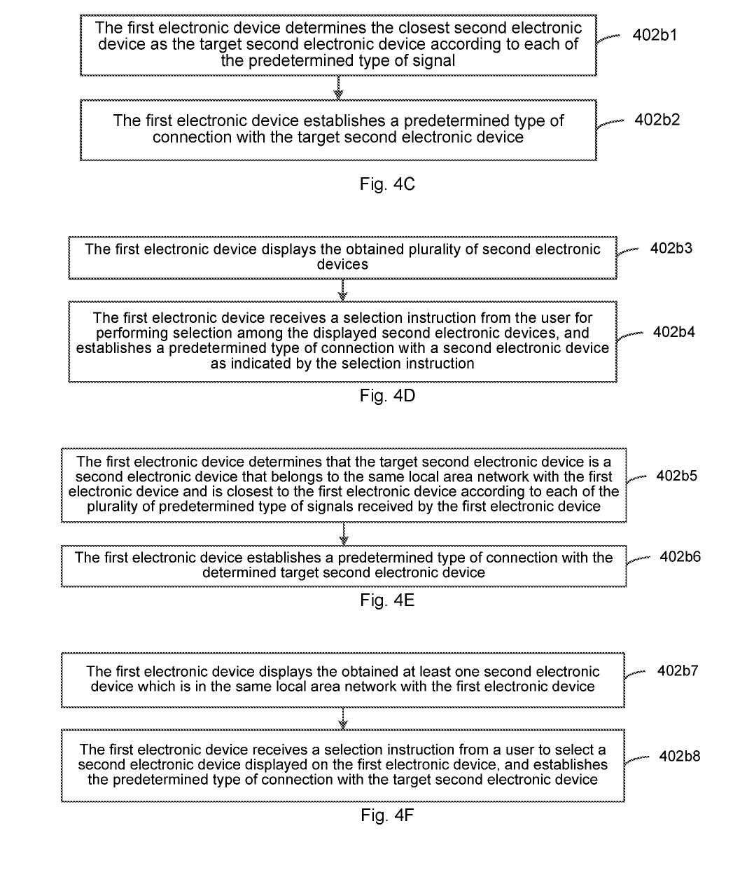

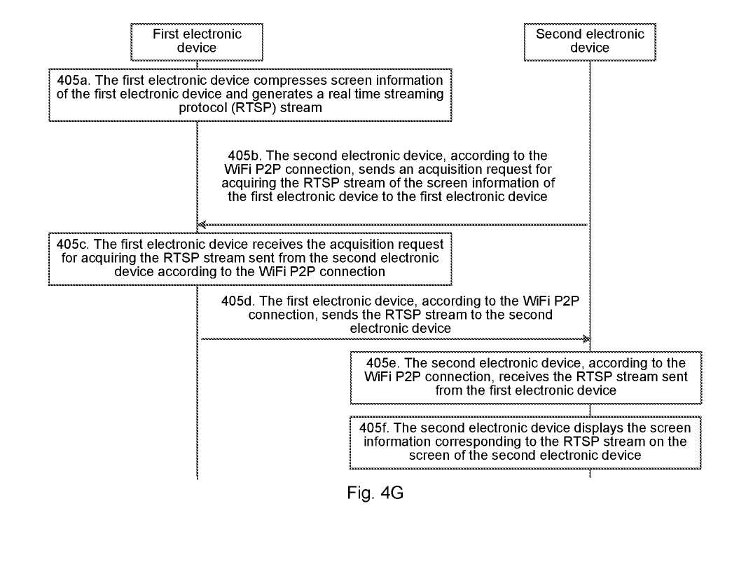

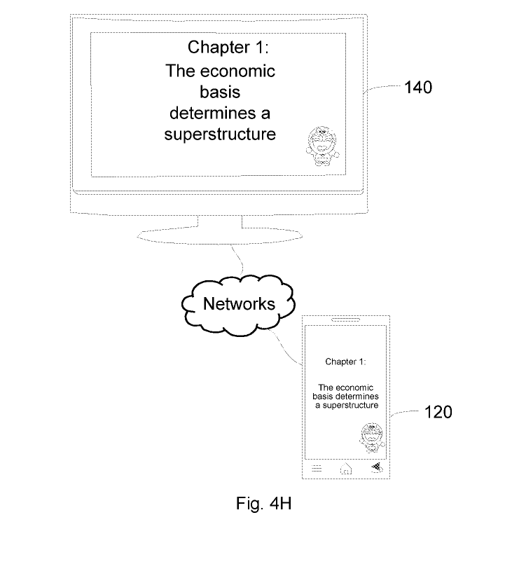

FIG. 4A is a flowchart showing a method of projecting on a screen according to another exemplary embodiment. The method of projecting on a screen may be applied in the implementation environment shown in FIG. 1. To this end, a processor of the electronic device 120 and/or 140 may execute a set of instructions stored in a non-transitory processor-readable storage medium of the electronic device 120 and/or 140, and is directed by the set of instructions to perform the following performances.

In step 401, at least one second electronic device each sends a predetermined type of signal by broadcast.

The predetermined type of signal may be Bluetooth signal, NFC signal or WiFi frames and the like.

According to an implementation, the second electronic device may generally broadcast default predetermined type of signal, i.e., the type of the signal may be a default for the second electronic device, so that the second electronic device does not need to install particular application program for broadcasting predetermined type of signal. Since the current electronic devices such as smart phones, smart TVs and other electronic devices in smart home have Bluetooth or NFC communication functions, these communications do not need to be manually started by a user. If the second electronic device has communication functions such as Bluetooth or NFC communication functions, the second electronic device may continuously broadcast Bluetooth signal or NFC signal by default.

In step 402, the first electronic device receives the at least one predetermined type of signal and establishes a predetermined type of connection with a target second electronic device from the at least one second electronic device which sends the predetermined type of signal.

The first electronic device may automatically establish the predetermined type of connection (e.g., a wireless connection) with the target second electronic device. The first electronic device may be within a predetermined range from the at least one second electronic device and may receive the predetermined type of signal sent from the at least one second electronic device. When the at least one second electronic device broadcasts the predetermined type of signal, the distance by which the predetermined type of signal can be transmitted may be limited by the protocol corresponding to the predetermined type of signal. For example, the transmission distance of a Bluetooth signal is typically within 10 meters, and the transmission distance of a NFC signal is typically within 10 centimeters. Thus, the first electronic device may receive the predetermined type of signal broadcast by the second electronic device only when it is within the predetermined range from the second electronic device, that is, the first electronic device may only receive the predetermined type of signal sent from a second electronic device which is within the predetermined range from the first electronic device.

After the first electronic device receives the predetermined type of signal, the first electronic device may establish the predetermined type of connection with the target second electronic device which sends the predetermined type of signal. The predetermined type of connection here may be used for transmitting the signal having the same type with the predetermined type of signal. For example, if the predetermined type of signal is Bluetooth signal, the predetermined type of connection may be a Bluetooth connection, i.e., the predetermined type of connection may be used for transmitting the Bluetooth signal.

In step 403, the first electronic device notifies the target second electronic device to start a WiFi P2P connection service according to the predetermined type of connection. The notification may be automatic.

After successful establishment of the predetermined type of connection, the first electronic device may notify the target second electronic device to start the WiFi P2P connection service according to the predetermined type of connection. For example, the first electronic device may, according to the predetermined type of connection, send a notification message to the target second electronic device. The type of the notification message may be the same as the type of the predetermined type of signal. The notification message is used for notifying the target second electronic device to start the WiFi P2P connection service of the second electronic device.

For example, after a Bluetooth connection is established, the first electronic device may send a Bluetooth signal to the target second electronic device via the established Bluetooth connection. The Bluetooth signal is used for notifying the target second electronic device to start the WiFi P2P connection service. As another example, after a NFC connection is established, the first electronic device may send a NFC signal to the target second electronic device via the established NFC connection. The NFC signal is used for notifying the target second electronic device to start the WiFi P2P connection service.

Generally, the WiFi P2P connection service is not started by default. In order to ensure the fluency of projection on screen when the projection is realized under the WiFi P2P connection and to reduce occupancy of the bandwidth, the first electronic device and the second electronic device which need to perform the projection may firstly start the WiFi P2P connection services. In the present embodiment, the first electronic device may employ the established predetermined type of connection to notify, on its own initiative, the second electronic device to start the WiFi P2P connection service of the second electronic device.

In step 404, after receiving the notification sent from the first electronic device according to the predetermined type of connection, the target second electronic device starts the WiFi P2P connection service.

After receiving the notification sent from the first electronic device according to the predetermined type of connection, the target second electronic device may start the WiFi P2P connection service. It can be seen that, the target second electronic device does not need to have particular application program for starting the WiFi P2P connection service but only needs to establish a predetermined type of connection and to start the WiFi P2P connection service under the triggering of the first electronic device. Further, a user does not need to perform any operation in the second electronic device. Consequently, the operation flow for starting the WiFi P2P connection is simplified.

In step 405, after the first electronic device starts the WiFi P2P connection service, the first electronic device establishes a WiFi P2P connection with the target second electronic device in which the WiFi P2P connection service has been started, and then performs projection onto a screen of the target second electronic device. The establishment of the WiFi P2P connection may be automatic.

After the first electronic device notifies the target second electronic device to start the WiFi P2P connection service according to the established predetermined type of connection, in order to guarantee successful establishment of WiFi P2P connection between the first electronic device and the target second electronic device, the first electronic device may automatically start the WiFi P2P connection service of the first electronic device. When both the first electronic device and the target second electronic device respectively start its own WiFi P2P connection service, a WiFi P2P connection may be established between the first electronic device and the target second electronic device.

Thus, the first electronic device may perform projection of a visual document onto a screen of the target second electronic device according to the established WiFi P2P connection. The visual document may be an image, a video document, a PPT file, or any other type of document that need to visually presented to a user.

In conclusion, in the method of projecting on a screen provided by the embodiment of the present disclosure, a predetermined type of connection with a second electronic device is automatically established according to received broadcast signal. Then, under the predetermined type of connection, a WiFi P2P connection service of the second electronic device is started and a WiFi P2P connection is established to perform projection on a screen. The received predetermined type of signal is sent by broadcast through the second electronic device by default, and thus there is no need to install particular application program in the first electronic device and the second electronic device, and a WiFi P2P connection is established without user's manual operation. Thus, the present embodiment may solve the problem in the related arts that particular application program needs to be installed in the first electronic device and the second electronic device, a WiFi P2P connection may be established upon user's operation only after the user simultaneously starts the particular application program in the two electronic devices by user's operation, resulting in cumbersome operations and low connection efficiency when performing projection on a screen. Consequently, the WiFi P2P connection may be established automatically, the connection efficiency when performing projection on a screen may be improved and user's operations may be reduced.

It should be noted that, the above steps 402, 403 and 405 may be separately implemented as a method of projecting on a screen executed by the first electronic device, and the above steps 401 and 404 may be separately implemented as a method of projecting on a screen executed by the second electronic device.

According to an exemplary embodiment, the predetermined type of signal received by the first electronic device may be sent from two or more second electronic devices, and in practical application scenarios, one of the second electronic devices may be selected to perform projection on a screen. That is, in step 402 in FIG. 4A, when the first electronic device receives the predetermined type of signal and establishes a predetermined type of connection with a second electronic device which sends the predetermined type of signal, as shown in FIG. 4B. FIG. 4B is a flowchart when a first electronic device establishes a predetermined type of connection with a second electronic device which sends the predetermined type of signal according to another exemplary embodiment. The process in FIG. 4B may be executed by the first electronic device, such as the electronic device 120. In the process, a processor of the first electronic device may execute a set of instructions stored in a non-transitory processor-readable storage medium of the first electronic device, and is directed by the set of instructions to perform the following performances.

In step 402a, the first electronic device analyzes each of a plurality of predetermined type of signals (or the at least one predetermined type of signal) it receives, and obtains the at least one target second electronic device which sends a target predetermined type of signal by broadcast.

The plurality of predetermined type of signals received by the first electronic device may be sent by a plurality of second electronic devices by broadcast, and thus, in order to obtain the second electronic devices which send the plurality of predetermined type of signals, the received plurality of predetermined type of signals may be analyzed, and at least one target second electronic device which sends the target predetermined type of signal may be determined according to the identifier field of the sending part carried in the target predetermined type of signal.

In step 402b, the first electronic device establishes a predetermined type of connection with the target second electronic device, wherein the target second electronic device is one of the plurality of second electronic devices satisfying a preset condition among the at least one second electronic device.

When the target predetermine type signal is Bluetooth signal or NFC signal, the preset condition for the target second electronic device may be a requirement that a second electronic device which is closest to the first electronic device among the obtained plurality of second electronic devices, or may be a requirement that a second electronic device which is selected by a user from the obtained respective second electronic devices.

When the predetermined type of signal is WiFi frames, the preset condition for the target second electronic device may be a requirement that the target second electronic device be in the same local area network with the first electronic device and being closest to the first electronic device among the obtained respective second electronic devices, or may be a requirement that the target second electronic device be a second electronic device which is selected by a user from the obtained respective second electronic devices which belong to the same local area network with the first electronic device.

According to the type of the signal, the first electronic device may establish a predetermined type of connection with the target second electronic device among the at least one second electronic device. Specifically, there may be the following four scenarios.

First Scenario

When the predetermined type of signal is Bluetooth signal or NFC signal, the first electronic device may establish a predetermined type of connection with a second electronic device which is closest to the first electronic device. As shown in FIG. 4C, the following steps may be included.

In step 402b1, the first electronic device determines the closest second electronic device as the target second electronic device according to each of the predetermined type of signal.

In step 402b2, the first electronic device establishes a predetermined type of connection with the target second electronic device.

In order to determine which one of the plurality of the second electronic devices is the closest second electronic devices, the first electronic device may conduct the following steps: firstly, from the predetermined type of signals received from the plurality of second electronic devices, obtaining signal strength of each of the predetermined type of signals and transmitting frequency for transmitting each of the predetermined type of signal; secondly, according to the obtained signal strength of each of the predetermined type of signals or according to the signal strength and the transmitting frequency of each of the predetermined type of signals, determining the target second electronic device as the closest to the first electronic device.

Generally, the shorter distance from the second electronic device to the first electronic device is, the stronger the strength of the signal of a predetermined type broadcasted by the second electronic device and received by the first electronic device will be. Thus, the target second electronic device, which is closest to the first electronic device, may be determined according to the signal strength of the predetermined type of signal.

Additionally, the transmitting frequencies of the plurality of predetermined type of signals broadcasted by the plurality of second electronic devices may be different. The differences among the transmitting frequencies may affect the corresponding signal strength of the predetermined type of signals received by the first electronic device, and thus the target second electronic device, which is closest to the first electronic device, may be determined by a combination of the signal strength and transmitting frequencies corresponding to the predetermined type of signal that the target second electronic device broadcasted.

Second Scenario

When the predetermined type of signal is Bluetooth signal or NFC signal, the first electronic device may establish the predetermined type of connection with a second electronic device which is selected by a user. As shown in FIG. 4D, the following steps may be included.

In step 402b3, the first electronic device displays the obtained plurality of second electronic devices.

In step 402b4, the first electronic device receives a selection instruction from the user for performing selection among the displayed second electronic devices, and establishes a predetermined type of connection with a second electronic device as indicated by the selection instruction.

The obtained plurality of second electronic devices is displayed on the first electronic device and the number of the obtained second electronic devices may be one, two or more.

The user may perform selection on the second electronic devices displayed on the first electronic device, and accordingly, the first electronic device may receive the selection instruction for performing selection on the displayed second electronic devices, and determine the second electronic device according to the selection instruction, and establish a predetermined type of connection with the determined second electronic device.

Third Scenario

When the predetermined type of signal is WiFi frames, the first electronic device may establish the predetermined type of connection with a second electronic device satisfying a preset condition among the at least one second electronic device. As shown in FIG. 4E, the following steps may be included.

In step 402b5, the first electronic device determines that the target second electronic device is a second electronic device that belongs to the same local area network with the first electronic device and is closest to the first electronic device according to each of the plurality of predetermined type of signals received by the first electronic device.

In step 402b6, the first electronic device establishes a predetermined type of connection with the determined target second electronic device.

When the predetermined type of signal is WiFi frames, accordingly, the available predetermined type of connection requires the first electronic device and the second electronic device be within the same local area network. Thus, in order to establish the predetermined type of connection, the first electronic device needs to select a second electronic device which is in the same local area network with the first electronic device among the determined second electronic devices.

In practical applications, the predetermined type of signal that a second electronic device may include at least one network identifier to identify the local area network that the second electronic device is in. The at least one network identifier may be embedded in a field of the predetermined type of signal. The first electronic device may analyze the fields in the plurality of predetermined type of signals it received and obtain the network identifiers therein that represent the local area networks in which the plurality of second electronic devices reside. The first electronic device may identify and/or obtain the second electronic devices which have the same network identifier as that of the first electronic device according to the network identifier of itself.

Further, from the identified second electronic devices that have the same network identifier as the first electronic device, the first electronic device may determine a second electronic device which is closest to the first electronic device as the target second electronic device. To this end, the following steps may be included: from the predetermined type of signals respectively sent from each of the above identified second electronic device, obtaining signal strength and frequency of each of the predetermined type of signals; and according to the obtained signal strength or the frequency of each of the predetermined type of signals, determining the second electronic device which is closest to the first electronic device as the target electronic device.

Fourth Scenario

When the predetermined type of signal is WiFi frames, the first electronic device may establish the predetermined type of connection with the target second electronic device satisfying a preset condition among the at least one second electronic device. As shown in FIG. 4F, the following steps may be included.

In step 402b7, the first electronic device displays the obtained at least one second electronic device (e.g., the plurality of second electronic devices) which is in the same local area network with the first electronic device.

In step 402b8, the first electronic device receives a selection instruction from a user to select a second electronic device (i.e., the target second electronic device) displayed on the first electronic device, and establishes the predetermined type of connection with the target second electronic device.

When the predetermined type of signal is WiFi frames, similarly, in order to establish the predetermined type of connection, the first electronic device needs to select second electronic devices which are in the same local area network with the first electronic device among determined second electronic devices, and displays the selected second electronic devices.

In order to better comply with user's practical use, a selection interface may be provided for a user to perform selection on the displayed second electronic devices, or the first electronic device may display a list for presenting respective second electronic devices and a user may select a second electronic device to which the projection is performed from these second electronic devices, and accordingly, the first electronic device receives a selection instruction for performing selection on the displayed second electronic devices and determines the selected second electronic device as indicated by the selection instruction, and then establishes a predetermined type of connection with the determined second electronic device.

In conclusion, in the method of projecting on a screen provided by the embodiment of the present disclosure, a second electronic device satisfying a preset condition is selected, and a predetermined type of connection with the second electronic device is established, and then according to the established predetermined type of connection, the second electronic device is triggered to start a WiFi P2P connection service and a WiFi P2P connection is established to realize projection on a screen. Since the WiFi P2P connection may be established with one of the second electronic devices, which satisfies a preset condition, it can be guaranteed that only a second electronic device which satisfies a preset condition can display screen information of the first electronic device and thereby this embodiment may be better adaptive to practical use scenarios.

Additionally, in step 405 of FIG. 4A, when the first electronic device performs projection onto a screen of the second electronic device, the first electronic device may perform the following steps, as shown in FIG. 4G.

In step 405a, the first electronic device compresses screen information of the first electronic device and generates a real time streaming protocol (RTSP) stream.

According to protocols relating to projection on a screen, in order to quickly project screen information of the first electronic device onto the second electronic device, the first electronic device may compress information displayed on the screen of the first electronic device and generates an RTSP stream. And, in the subsequent visual projection procedure, the first electronic device continuously compresses the information recently displayed on the screen of the first electronic device to generate an RTSP stream.

In step 405b, the second electronic device, according to the WiFi P2P connection, sends an acquisition request for acquiring the RTSP stream of the screen information of the first electronic device to the first electronic device.

In practice, after establishing the WiFi P2P connection with the first electronic device, when it is needed to display the screen information on the screen of the first electronic device, the second electronic device may send an acquisition request for acquiring the RTSP stream to the first electronic device according to the established WiFi P2P connection.

According to an exemplary embodiment, after establishing the WiFi P2P connection with the second electronic device, the first electronic device may directly push the RTSP stream generated by compression to the second electronic device.

In step 405c, the first electronic device receives the acquisition request for acquiring the RTSP stream sent from the second electronic device according to the WiFi P2P connection.

In step 405d, the first electronic device, according to the WiFi P2P connection, sends the RTSP stream to the second electronic device.

The RTSP stream may be configured to trigger the second electronic device to display the screen information corresponding to the RTSP stream on the screen of the second electronic device.

In step 405e, the second electronic device, according to the WiFi P2P connection, receives the RTSP stream sent from the first electronic device.

In step 405f, the second electronic device displays the screen information corresponding to the RTSP stream on the screen of the second electronic device.

Generally, in the subsequent process of projection on the screen, the first electronic device may send recently generated RTSP stream to the second electronic device in a real-time manner only if the WiFi P2P connection is not interrupted, so that the second electronic device may synchronously display the screen information of the first electronic device.

FIG. 4H is a block diagram illustrating a procedure to synchronously display screen information of a first electronic device on the screen of a second electronic device according to another exemplary embodiment. In FIG. 4H, the information displayed on the screen of the second electronic device 140 and the information displayed on the screen of the first electronic device 120 are the same. In the procedure the first electronic device and the second electronic device may be the electronic device shown in FIG. 9, wherein a processor of the first and/or the second electronic device may execute a set of instructions stored in a non-transitory processor-readable storage medium thereof t, and is directed by the set of instructions to perform the following performances.

Optionally, when it is not needed to display the screen information of the first electronic device on the second electronic device, the RTSP stream sent from the first electronic device may be directly discarded, or a request for projection interruption may be sent to the first electronic device. The request for projection interruption may be configured to trigger the first electronic device to interrupt compression of the screen information of the first electronic device and to interrupt sending of the RTSP stream to the second electronic device, or the WiFi P2P connection with the first electronic device may be interrupted.

In conclusion, in the method of projecting on a screen provided by embodiments of the present disclosure, the screen information of the first electronic device is compressed to form an RTSP stream, and when accessed by the second electronic device, the RTSP stream is sent to the second electronic device to make the second electronic device correspondingly display the screen information of the first electronic device according to the RTSP stream. Thus, the projection of the screen information of the first electronic device onto the screen of the second electronic device is realized. Consequently, the practical viewing demand of viewing the screen information of the first electronic device on the second electronic device is satisfied.

It should be noted that the above step 405a may be performed after the above step 405c, and the present embodiment does not impose specific limitation on the sequence of the steps 405a and 405c. The above steps 405a, 405c and 405d may be separately implemented as a method of projecting on a screen executed by the first electronic device, and the above steps 405b, 405e and 405f may be separately implemented as a method of projecting on a screen executed by the second electronic device.

According to an exemplary embodiment, the first electronic device may simultaneously project the screen information onto at least two second electronic devices. That is, a second electronic device satisfying a preset condition may include respective second electronic devices determined by the first electronic device, or may be second electronic devices of a designated type determined by the first electronic device, or may be respective designated second electronic devices which are closest to the first electronic device, and determined by the first electronic device.

For example, the first electronic device may perform projection on screens of respective determined second electronic devices. As another example, the first electronic device may perform projection on a screen of a second electronic device of a designated type such as a mobile phone, or may perform projection on a screen of a second electronic device of a designated type such as a mobile phone and on a screen of a second electronic device of a designated type such as a smart TV. As another example, the first electronic device may perform projection on screens of three second electronic devices which are relatively adjacent to the first electronic device.

In practical application scenario, a user may want to synchronously display the screen information of a mobile phone (i.e., the first electronic device) held by him/her to a plurality of guests, and at this time, the screen information of the mobile phone held by the user may be projected on a TV (i.e., the second electronic device) in a sitting room so that all the other guests may obtain the screen information of the first electronic device via the TV in the sitting room. Thus, information synchronization and share are realized. Optionally, if the user wants to synchronously display the screen information of the mobile phone to a guest in a study room, the user may project the screen information of the mobile phone onto the mobile phone of the user in the study room. Thus, information synchronization and share among devices in respective rooms are realized and thereby user experience is improved.

FIG. 4I is a block diagram when projection is performed on two screens of two different types of second electronic devices according to another exemplary embodiment. The first electronic device 120 concurrently projects the screen information onto a second electronic device 140 of a type of a smart TV and a second electronic device 140 of a type of a smart phone.

Embodiments of devices of the present disclosure configured to perform the above methods of the present disclosure will be described below. For the undisclosed details of the devices of the present disclosure, please see the embodiments of the methods of the present disclosure.

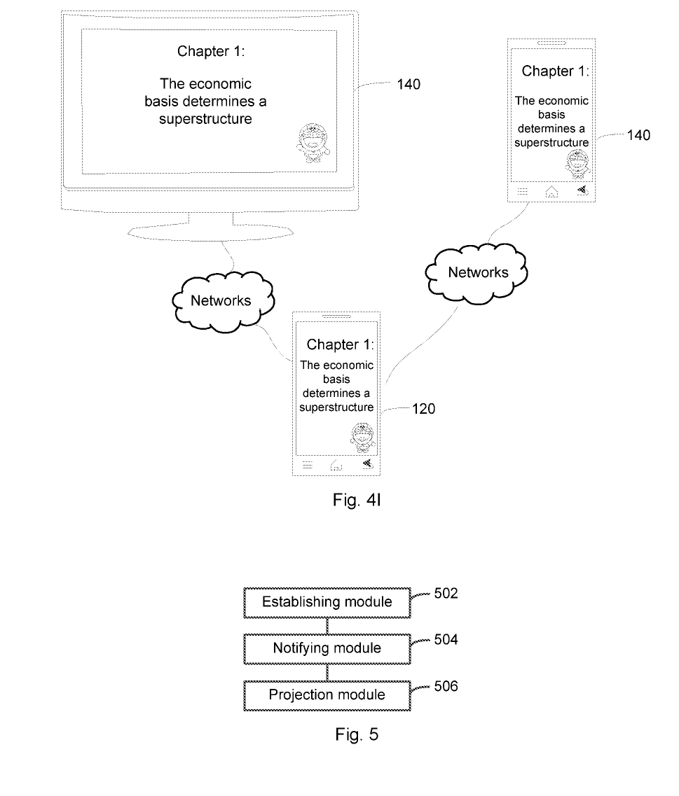

FIG. 5 is a block diagram showing a device for projection on a screen according to another exemplary embodiment. As shown in FIG. 5, the device for projection on a screen is applied in the first electronic device 120 in the implementation environment as shown in FIG. 1. The device for projection on a screen may be implemented as a part of the first electronic device by software, hardware, circuitry, or combination thereof. The device for projection on a screen may include but not limited to: an establishing module 502, a notifying module 504 and a projection module 506. Each module may be in a form of the above software, hardware, circuitry, or combination thereof.

The establishing module 502 may be configured to receive predetermined type of signal, and establish a predetermined type of connection with a second electronic device which sends the predetermined type of signal. The predetermined type of connection may be configured to transmit signal having the same type with the predetermined type of signal.

The notifying module 504 is configured to, according to the predetermined type of connection established by the establishing module 502, notify the second electronic device to start a WiFi P2P connection service.

The projection module 506 is configured to, after the first electronic device starting the WiFi P2P connection service, establish a WiFi P2P connection with the second electronic device which has started the WiFi P2P connection service, and perform projection on a screen of the second electronic device.

In conclusion, in the device for projection on a screen provided by the embodiment of the present disclosure, a predetermined type of connection with a second electronic device is automatically established according to received broadcast signal. Then, under the predetermined type of connection, a WiFi P2P connection service of the second electronic device is started and a WiFi P2P connection is established to perform projection on a screen. The received predetermined type of signal is sent by broadcast through the second electronic device by default, and thus there is no need to install particular application program in the first electronic device and the second electronic device, and a WiFi P2P connection is established without user's manual operation. Thus, the present embodiment may solve the problem in the related arts that particular application program needs to be installed in the first electronic device and the second electronic device, a WiFi P2P connection may be established upon user's operation only after the user simultaneously starts the particular application program in the two electronic devices by user's operation, resulting in cumbersome operations and low connection efficiency when performing projection on a screen. Consequently, the WiFi P2P connection may be established automatically, the connection efficiency when performing projection on a screen may be improved and user's operations may be reduced.

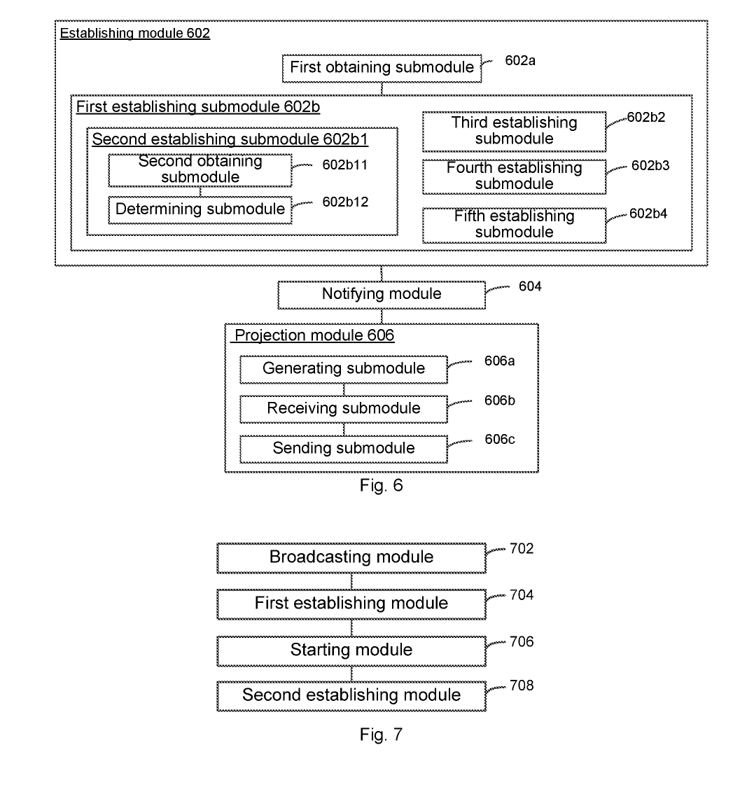

FIG. 6 is a block diagram showing a device for projection on a screen according to another exemplary embodiment. As shown in FIG. 6, the device for projection on a screen is applied in the first electronic device 120 in the implementation environment as shown in FIG. 1. The device for projection on a screen may be implemented as a part of the first electronic device by software, hardware or combination thereof. The device for projection on a screen may include but not limited to: an establishing module 602, a notifying module 604 and a projection module 606.

The establishing module 602 may be configured to receive predetermined type of signal, and establish a predetermined type of connection with a second electronic device which sends the predetermined type of signal. The predetermined type of connection may be configured to transmit signal having the same type with the predetermined type of signal.

The notifying module 604 is configured to, according to the predetermined type of connection established by the establishing module 602, notify the second electronic device to start a WiFi P2P connection service.

The projection module 606 is configured to, after the first electronic device starting the WiFi P2P connection service, establish a WiFi P2P connection with the second electronic device which has started the WiFi P2P connection service, and perform projection on a screen of the second electronic device.

In an exemplary embodiment, the establishing module 602 may include a first obtaining submodule 602a and a first establishing submodule 602b.

The first obtaining submodule 602a may be configured to analyze each of the predetermined type of signal, and obtain at least one second electronic device which sends the predetermined type of signal by broadcast.

The first establishing submodule 602b may be configured to establish the predetermined type of connection with a second electronic device satisfying a preset condition among the at least one second electronic device obtained by the first obtaining submodule 602a.

In another exemplary embodiment, the predetermined type of signal is a Bluetooth signal or a NFC signal, and the first establishing submodule 602b may include a second establishing submodule 602b1 configured to, according to each of the predetermined types of signals, determine a second electronic device which is closest to the first electronic device and establish the predetermined type of connection with the determined second electronic device. Alternatively, a third establishing submodule 602b2 may be configured to display second electronic devices obtained by the first obtaining submodule 602a, receive a selection instruction for performing selection on the displayed second electronic devices, and establish the predetermined type of connection with a second electronic device as indicated by the selection instruction.

In an exemplary embodiment, the second establishing submodule 602b1 may include a second obtaining submodule 602b11 configured to, from the predetermined type of signal, obtain signal strength of each of the predetermined type of signal and the transmitting frequency for transmitting each of the predetermined type of signal. The second establishing submodule may also include a determining submodule 602b12 configured to, according to the obtained signal strength of each of the predetermined type of signal or according to the signal strength and the transmitting frequency of each of the predetermined type of signal obtained by the second obtaining submodule 602b11, determine the second electronic device which is closest to the first electronic device.

In another exemplary embodiment, the predetermined type of signal is WiFi signal, and the first establishing submodule 602b may include: a fourth establishing submodule 602b3 configured to, according to each of the predetermined type of signal, determine a second electronic device which belongs to the same local area network with the first electronic device and is closest to the first electronic device, and establish the predetermined type of connection with the determined second electronic device; or a fifth establishing submodule 602b4 configured to display second electronic devices which are obtained by the first obtaining submodule 602a and belong to the same local area network with the first electronic device, receive a selection instruction for performing selection on the displayed second electronic devices, and establish the predetermined type of connection with a second electronic device as indicated by the selection instruction.

In another exemplary embodiment, the projection module 606 may include a generating submodule 606a, a receiving submodule 606b and a sending submodule 606c.

The generating submodule 606a may be configured to compress screen information of the first electronic device and generate an RTSP stream.

The receiving submodule 606b may be configured to receive an acquisition request for acquiring the RTSP stream sent by the second electronic device via the WiFi P2P connection.

The sending submodule 606c is configured to, via the WiFi P2P connection, send the RTSP stream generated by the generating submodule to the second electronic device. The RTSP stream may be configured to trigger the second electronic device to display screen information corresponding to the RTSP stream on the screen of the second electronic device.

In the device for projection on a screen provided by an embodiment of the present disclosure, a predetermined type of connection with a second electronic device is automatically established according to received broadcast signal. Then, under the predetermined type of connection, a WiFi P2P connection service of the second electronic device is started and a WiFi P2P connection is established to perform projection on a screen. The received predetermined type of signal is sent by broadcast through the second electronic device by default, and thus there is no need to install particular application program in the first electronic device and the second electronic device, and a WiFi P2P connection is established without user's manual operation.

In the device for projection on a screen provided by the embodiment of the present disclosure, a second electronic device satisfying a preset condition is selected, and a predetermined type of connection with the second electronic device is established, and then according to the established predetermined type of connection, the second electronic device is triggered to start a WiFi P2P connection service and a WiFi P2P connection is established to realize projection on a screen. Since the WiFi P2P connection may be established with one of the second electronic devices, which satisfies a preset condition, it can be guaranteed that only a second electronic device which satisfies a preset condition can display screen information of the first electronic device and thereby this embodiment may be better adaptive to practical use scenarios.

In the device for projection on a screen provided by the embodiment of the present disclosure, the screen information of the first electronic device is compressed to form an RTSP stream, and when accessed by the second electronic device, the RTSP stream is sent to the second electronic device to make the second electronic device correspondingly display the screen information of the first electronic device according to the RTSP stream. Thus, the projection of the screen information of the first electronic device onto the screen of the second electronic device is realized. Consequently, the practical viewing demand of viewing the screen information of the first electronic device on the second electronic device is satisfied.

FIG. 7 is a block diagram showing a device for projection on a screen according to another exemplary embodiment. As shown in FIG. 7, the device for projection on a screen is applied in the second electronic device 140 in the implementation environment as shown in FIG. 1. The device for projection on a screen may be implemented as a part of the second electronic device by software, hardware or combination thereof. The device for projection on a screen may include but not limited to: a broadcasting module 702, a first establishing module 704, a starting module 706 and a second establishing module 708.

The broadcasting module 702 may be configured to send predetermined type of signal by broadcast.

The first establishing module 704 may be configured to establish a predetermined type of connection with a first electronic device. The predetermined type of connection may be configured to transmit signal having the same type with the predetermined type of signal broadcast by the broadcasting module.

The starting module 706 is configured to, after receiving a notification sent by the first electronic device via the predetermined type of connection established by the first establishing module 704, start a WiFi P2P connection service.

The second establishing module 708 may be configured to establish a WiFi P2P connection with the first electronic device which has started the WiFi P2P connection service. The WiFi P2P connection may be configured to realize projection on a screen of the second electronic device by the first electronic device.

In conclusion, in the device for projection on a screen provided by the embodiment of the present disclosure, predetermined type of signal is broadcast and thus a first electronic device may receive the predetermined type of signal. Thereby, a predetermined type of connection may be automatically established with a second electronic device. Then, under the predetermined type of connection, a WiFi P2P connection service of the second electronic device is started, and a WiFi P2P connection is established to perform projection on a screen. The second electronic device may send the predetermined type of signal by broadcast, and there is no need to install particular application program and no cumbersome operations of a user is needed.

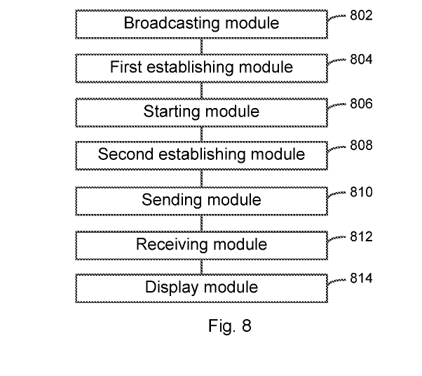

FIG. 8 is a block diagram showing a device for projection on a screen according to another exemplary embodiment. As shown in FIG. 8, the device for projection on a screen is applied in the second electronic device 140 in the implementation environment as shown in FIG. 1. The device for projection on a screen may be implemented as a part of the second electronic device by software, hardware or combination thereof. The device for projection on a screen may include but not limited to: a broadcasting module 802, a first establishing module 804, a starting module 806 and a second establishing module 808.

The broadcasting module 802 may be configured to send predetermined type of signal by broadcast.

The first establishing module 804 may be configured to establish a predetermined type of connection with a first electronic device. The predetermined type of connection may be configured to transmit signal having the same type with the predetermined type of signal broadcast by the broadcasting module 802.

The starting module 806 is configured to, after receiving a notification sent by the first electronic device via the predetermined type of connection established by the first establishing module 804, start a WiFi P2P connection service.

The second establishing module 808 may be configured to establish a WiFi P2P connection with the first electronic device which has started the WiFi P2P connection service. The WiFi P2P connection may be configured to realize projection on a screen of the second electronic device by the first electronic device.

In an exemplary embodiment, the device for projection on a screen may further include a sending module 810, a receiving module 812 and a display module 814.

The sending module 810 is configured to, according to the WiFi P2P connection, send to the first electronic device an acquisition request for acquiring a real time streaming protocol (RTSP) stream of screen information of the first electronic device.

The receiving module 812 is configured to, according to the WiFi P2P connection, receive the RTSP stream sent from the first electronic device. The RTSP stream is obtained by compression of screen information of the first electronic device through the first electronic device.

The display module 814 may be configured to display screen information corresponding to the RTSP stream on the screen of the second electronic device.

In conclusion, in the device for projection on a screen provided by the embodiment of the present disclosure, predetermined type of signal is broadcast and thus a first electronic device may receive the predetermined type of signal. Thereby, a predetermined type of connection may be automatically established with a second electronic device. Then, under the predetermined type of connection, a WiFi P2P connection service of the second electronic device is started, and a WiFi P2P connection is established to perform projection on a screen. The second electronic device may send the predetermined type of signal by broadcast, and there is no need to install particular application program and no cumbersome operations of a user is needed.

With respect to the devices in the above embodiments, specific operations performed by respective modules have been described in detail in the embodiments of the methods and therefore repeated descriptions are omitted here.

An exemplary embodiment of the present disclosure may provide a system for projection on a screen which may include a first electronic device and a second electronic device. The first electronic device may include the device for projection on a screen as shown in FIG. 5 or 6, and the second electronic device may include the device for projection on a screen as shown in FIG. 7 or 8. For details, please see the description regarding FIGS. 5 to 8 and repeated descriptions are omitted here.

An exemplary embodiment of the present disclosure may provide a device for projection on a screen which is capable of realizing the method of projecting on a screen provided by the present disclosure. The device for projection on a screen is applied in a first electronic device and may include: a processor; and a memory for storing instructions executable by the processor; wherein the processor may be configured to perform: receiving predetermined type of signal, and establishing a predetermined type of connection with a second electronic device which sends the predetermined type of signal, the predetermined type of connection being configured to transmit signal having the same type with the predetermined type of signal; according to the predetermined type of connection, notifying the second electronic device to start a WiFi P2P connection service; and after the first electronic device starting the WiFi P2P connection service, establishing a WiFi P2P connection with the second electronic device which has started the WiFi P2P connection service, and performing projection on a screen of the second electronic device.

An exemplary embodiment of the present disclosure further may provide a device for projection on a screen which is capable of realizing the method of projecting on a screen provided by the present disclosure. The device for projection on a screen is applied in a second electronic device and may include: a processor; and a memory for storing instructions executable by the processor; wherein the processor may be configured to perform: sending predetermined type of signal by broadcast; establishing a predetermined type of connection with a first electronic device, the predetermined type of connection being configured to transmit signal having the same type with the predetermined type of signal; after receiving a notification sent by the first electronic device via the predetermined type of connection, starting a WiFi P2P connection service; and establishing a WiFi P2P connection with the first electronic device which has started the WiFi P2P connection service, the WiFi P2P connection being configured to realize projection on a screen of the second electronic device by the first electronic device.

Thus, the present disclosure may solve the problem in the related arts that particular application program needs to be installed in the first electronic device and the second electronic device, a WiFi P2P connection may be established upon user's operation only after the user simultaneously starts the particular application program in the two electronic devices by user's operation, resulting in cumbersome operations and low connection efficiency when performing projection on a screen. Consequently, the WiFi P2P connection may be established automatically, the connection efficiency when performing projection on a screen may be improved and user's operations may be reduced.

Other embodiments of the present disclosure will be apparent to those skilled in the art from consideration of the specification and practice of the present disclosure disclosed here. This application is intended to cover any variations, uses, or adaptations of the present disclosure following the general principles thereof and including such departures from the present disclosure as come within known or customary practice in the art. It is intended that the specification and examples be considered as exemplary only, with a true scope and spirit of the present disclosure being indicated by the following claims.

It will be appreciated that the present disclosure is not limited to the exact construction that has been described above and illustrated in the accompanying drawings, and that various modifications and changes can be made without departing from the scope thereof. It is intended that the scope of the present disclosure only be limited by the appended claims.

1. A smart system, comprising a first electronic device, wherein the first electronic device comprises:
a non-transitory processor-readable storage medium comprising a set of instructions for wirelessly projecting a document to another electronic device and a target document; and
a processor in communication with the storage medium, wherein the processor is configured by the set of instructions to:
receive at least one wireless signal respectively broadcasted from at least one second electronic device;
automatically establish a wireless connection with a target second electronic device from the at least one second electronic device;
automatically notify the target second electronic device to start a wireless fidelity peer-to-peer (WiFi P2P) connection service according to the wireless connection;
automatically establish a WiFi P2P connection with the target second electronic device; and
send a visual portion of the target document displayed on the first electronic device to the target second electronic device through the WiFi P2P connection to display the visual portion on a screen of the target second electronic device.

2. The smart system according to claim 1, wherein the wireless signal comprises at least one of a Bluetooth signal or Near Field Communication (NFC) signal; and
wherein to establish the wireless connection with the second electronic device the processor is further configured to:
identify the at least one second electronic device based on the respective at least one wireless signal;
identify, from the at least one second electronic device, a second electronic device closest to the first electronic device as the target second electronic device according to the at least one wireless signal; and
establish the wireless connection with the target second electronic device.

3. The smart system according to claim 2, wherein to identify the second electronic device closest to the first electronic device the processor is further configured to:
for each of the at least one wireless signal, obtain at least one of signal strength of the wireless signal or frequency of the wireless signal; and
determine the second electronic device closest to the first electronic device based on at the least one of the signal strength or the frequency of the at least one wireless signal.

4. The smart system according to claim 1, wherein the wireless signal comprises at least one of a Bluetooth signal or Near Field Communication (NFC) signal; and
wherein to establish the wireless connection with the second electronic device the processor is further configured to:
identify the at least one second electronic device based on the respective at least one wireless signal;
display the at least one second electronic device;
receive a selection instruction from a user to select the target second electronic device from the at least one second electronic device; and
automatically establish the wireless connection with the target second electronic device in response to the selection instruction.

5. The smart system according to claim 1, wherein the at least one wireless signal comprises WiFi frames, and
wherein to establish the wireless connection with the second electronic device the processor is further configured to:
identify the at least one second electronic device based on the respective at least one wireless signal;
identify, from the at least one second electronic device, a second electronic device which belongs to a same local area network as the first electronic device and is closest to the first electronic device as the target second electronic device according to the at least one wireless signal; and
establish the wireless connection with the target second electronic device.

6. The smart system according to claim 1, wherein the at least one wireless signal comprises WiFi frames, and
wherein to establish the wireless connection with the second electronic device the processor is further configured to:
identify the at least one second electronic device based on the respective at least one wireless signal;
display, from the at least one second electronic device, at least one candidate second electronic device which belongs to a same local area network as the first electronic device;
receive a selection instruction from a user to select the target second electronic device from the at least one candidate second electronic device; and
establish the wireless connection with the target second electronic device.

7. The smart system according to claim 1, wherein to send the visual portion of the target document to the target second electronic device the processor is further configured to:
compress screen information of the first electronic device;
generate a real time streaming protocol (RTSP) stream;
receive a request for the RTSP stream from the target second electronic device via the WiFi P2P connection; and
in response to receipt of the request, send the RTSP stream to the second electronic device via the WiFi P2P connection, wherein the RTSP stream is configured to trigger the target second electronic device to synchronously display the screen information corresponding to the RTSP stream on the screen of the second electronic device.

8. A method for projecting a document on a screen, comprising:
receiving, by a first electronic device, at least one wireless signal respectively broadcasted from at least one second electronic device;
automatically establishing, by the first electronic device, a wireless connection with a target second electronic device from the at least one second electronic device;
automatically notifying, by the first electronic device, the target second electronic device to start a wireless fidelity peer-to-peer (WiFi P2P) connection service according to the wireless connection;
establishing, by the first electronic device, a WiFi P2P connection with the target second electronic device; and
sending, by the first electronic device, a visual portion of a target document displayed on the first electronic device to the target second electronic device through the WiFi P2P connection to display the visual portion on a screen of the target second electronic device.

9. The method according to claim 8, wherein the wireless signal comprises at least one of a Bluetooth signal or Near Field Communication (NFC) signal; and
wherein the establishing of the wireless connection with the second electronic device comprises:
identifying the at least one second electronic device based on the respective at least one wireless signal;
identifying, from the at least one second electronic device, a second electronic device closest to the first electronic device as the target second electronic device according to the at least one wireless signal; and
establishing the wireless connection with the target second electronic device.

10. The method according to claim 9, wherein the identifying of the second electronic device closest to the first electronic device comprises:
for each of the at least one wireless signal, obtaining at least one of signal strength of the wireless signal or frequency of the wireless signal; and
determining the second electronic device closest to the first electronic device based on at least one of the signal strength or the frequency of the at least one wireless signal.

11. The method according to claim 8, wherein the wireless signal comprises at least one of a Bluetooth signal or Near Field Communication (NFC) signal; and
wherein the establishing of the wireless connection with the second electronic device comprises:
identifying the at least one second electronic device based on the respective at least one wireless signal;
displaying the at least one second electronic device;
receiving a selection instruction from a user to select the target second electronic device from the at least one second electronic device; and
establishing the wireless connection with the target second electronic device in response to the selection instruction.

12. The method according to claim 8, wherein the at least one wireless signal comprises WiFi frames, and
wherein the establishing of the wireless connection with the second electronic device comprises:
identifying the at least one second electronic device based on the respective at least one wireless signal;
identifying, from the at least one second electronic device, a second electronic device which belongs to a same local area network as the first electronic device and is closest to the first electronic device as the target second electronic device according to the at least one wireless signal; and
establishing the wireless connection with the target second electronic device.

13. The method according to claim 8, wherein the at least one wireless signal comprises WiFi frames, and
wherein the establishing of the wireless connection with the second electronic device comprises:
identifying the at least one second electronic device based on the respective at least one wireless signal;
displaying, from the at least one second electronic devices, at least one candidate second electronic device which belong to a same local area network with the first electronic device;
receiving a selection instruction from a user to select the target second electronic device from the at least one candidate second electronic device; and
establishing the wireless connection with the target second electronic device.

14. The method according to claim 8, wherein the sending of the visual portion of the target document to the target second electronic device comprises:
compressing screen information of the first electronic device;
generating a real time streaming protocol (RTSP) stream;
receiving a request for the RTSP stream from the target second electronic device via the WiFi P2P connection; and
sending the RTSP stream to the second electronic device via the WiFi P2P connection, wherein the RTSP stream is configured to trigger the target second electronic device to synchronously display the screen information corresponding to the RTSP stream on the screen of the second electronic device.

15. A non-transitory processor-readable storage medium, comprising:
a set of instructions for wirelessly projecting a document from a first electronic device to another electronic device; and
a target document,
wherein when executed by a processor of the first electronic device, the set of instructions directs the processor to:
receive at least one wireless signal respectively broadcasted from at least one second electronic device;
automatically establish a wireless connection with a target second electronic device from the at least one second electronic device;
automatically notify the target second electronic device to start a wireless fidelity peer-to-peer (WiFi P2P) connection service according to the wireless connection; and
establish a WiFi P2P connection with the target second electronic device; and
send a visual portion of the target document displayed on the first electronic device to the target second electronic device through the WiFi P2P connection to display the visual portion on a screen of the target second electronic device.

16. The storage medium according to claim 15, wherein the wireless signal comprises at least one of a Bluetooth signal or Near Field Communication (NFC) signal; and
wherein, to establish the wireless connection with the second electronic device, the set of instructions further comprises instructions to cause the processor to:
identify the at least one second electronic device based on the respective at least one wireless signal;
identify, from the at least one second electronic device, a second electronic device closest to the first electronic device as the target second electronic device according to the at least one wireless signal; and
establish the wireless connection with the target second electronic device.

17. The storage medium according to claim 16, wherein to identify of the second electronic device closest to the first electronic device the set of instructions further comprises instructions to cause the processor to:
for each of the at least one wireless signal, obtain at least one of signal strength of the wireless signal or frequency of the wireless signal; and
determine the second electronic device closest to the first electronic device based on at least one of the signal strength and frequency of the at least one wireless signal.

18. The storage medium according to claim 15, wherein the wireless signal comprises at least one of a Bluetooth signal or Near Field Communication (NFC) signal; and
wherein, to establish the wireless connection with the second electronic device, the set of instructions further comprises instructions for causing the processor to:
identify the at least one second electronic device based on the respective at least one wireless signal;
display the at least one second electronic device;
receive a selection instruction from a user to select the target second electronic device from the at least one second electronic device; and
establish the wireless connection with the target second electronic device in response to the selection instruction.

19. The storage medium according to claim 15, wherein the at least one wireless signal comprises WiFi frames, and
wherein to establish the wireless connection with the second electronic device, the set of instructions further comprises instructions for causing the processor to:
identify the at least one second electronic device based on the respective at least one wireless signal;
identify, from the at least one second electronic device, a second electronic device which belongs to a same local area network with the first electronic device and is closest to the first electronic device as the target second electronic device according to the at least one wireless signal;
establish the wireless connection with the target second electronic device.

20. The storage medium according to claim 15, wherein to send the visual portion of the target document to the target second electronic device the set of instructions further comprises instructions to cause the processor to:
compress screen information of the first electronic device;
generate a real time streaming protocol (RTSP) stream;
receive a request of the RTSP stream from the target second electronic device via the WiFi P2P connection; and
send the RTSP stream to the second electronic device via the WiFi P2P connection, wherein the RTSP stream is configured to trigger the target second electronic device to synchronously display the screen information corresponding to the RTSP stream on the screen of the second electronic device.
